(19) United States
(12) Patent Application Publication
(10) Pub. No.: US 2002/0054846 A1
(43) Pub. Date: May 9, 2002

(54) REACTIVE POWDER COMPOSITION AND METHOD FOR PURIFYING GAS

(76) Inventors: NILO FAGIOLINI, ROSIGNANO-SOLVAY/LI (IT); GUY DEPELSENAIRE, COURT-SAINT-ETIENNE (BE); PASCAL BERTEAU, LOUVAIN-LA-NEUVE (BE)

Correspondence Address: SPENCER & FRANK, 1100 NEW YORK AVENUE NW, SUITE 300 EAST, WASHINGTON, DC, 200053955

(21) Appl. No.: 09/423,746

(22) PCT Filed: May 7, 1998
(86) PCT No.: PCT/EP98/02828

(30) Foreign Application Priority Data
May 14, 1997 (BE) 9700417

(51) Int. Cl. B01D 53/74; C01B 31/24

(52) U.S. Cl. 423/267; 423/422; 252/182.32; 423/210; 423/240 S; 423/239.1; 423/244.07; 423/244.08; 423/245.1

(57) ABSTRACT

Solid pulverulent reactive composition for the purification of a gas, the said composition comprising sodium bicarbonate and a caking inhibitor for sodium bicarbonate comprising lignite coke and/or a magnesium compound comprising magnesium (hydr)oxide. Process for the purification of a gas, according to which a reactive composition comprising sodium bicarbonate which is substantially devoid of silica is introduced into the gas and the gas is subjected to removal of dust.

The invention relates to the purification of gases.

It relates more particularly to a reactive composition based on sodium bicarbonate which can be used for the purification of gases.

Human activities generate large amounts of gases contaminated by toxic substances. Hydrogen chloride, hydrogen fluoride, sulphur oxides, nitrogen oxides, dioxins and furans are examples of toxic substances which are frequently found in these gases. Variable amounts of them are found in particular in the flue gases generated by plants for the incineration of domestic or hospital waste and in the flue gases generated by the combustion of fossil fuels, in particular in thermal power stations for the generation of electricity and in centralized district heating plants. These flue gases generally have to be freed from these toxic substances before being discharged to the atmosphere.

The Neutrec® process [Solvay (Sociéte Anonyme)] is an efficient process for purifying gases. According to this known process, sodium bicarbonate, in the form of a powder, is injected into the gas and the gas thus treated is subsequently conveyed to a filter for removal of the dust therefrom (Solvay S. A., booklet Br. 1566a-B-1-0396).

Sodium bicarbonate powder has a natural tendency to cake, which constitutes a disadvantage. The addition of silica thereto has been contemplated in order to combat this disadvantageous property of sodium bicarbonate (Klein Kurt—“Grundlagen und Anwendungen einer durch Flammenhydrolyse gewonnenen Kieselsäure: Teil 4: Aerosil zur Verbesserung des Fliessverhaltens pulverförmiger Substanzen” [Principles and applications of a silica produced by flame hydrolysis: Part 4: Aerosil for the improvement of the flow characteristics of pulverulent substances]—Seifen-Ole-Fette-Wachse—Nov. 20, 1969, p. 849-858). However, sodium bicarbonate to which silica has been added has not proved to be very satisfactory in the purification of gases comprising hydrogen chloride.

The invention overcomes this disadvantage by providing a pulverulent reactive composition comprising sodium bicarbonate which exhibits good resistance to caking and satisfactory effectiveness in purifying a gas.

The invention consequently relates to a solid pulverulent reactive composition for the purification of a gas, the said composition comprising sodium bicarbonate and a caking inhibitor for sodium bicarbonate and being characterized in that the inhibitor comprises lignite coke and/or a magnesium compound comprising magnesium (hydr)oxide.

Lignite coke is a product obtained by carbonization of lignite, which is a solid fossil fuel exhibiting a calorific value of less than 8,300 Btu/lb (19.3 kJ/g) according to ASTM Standard D 388 (Ullmann's Encyclopedia of Industrial Chemistry, 5th Edition, Vol. A 7, 1986, pages 160-161).

The term “magnesium (hydr)oxide” is understood to denote simultaneously magnesium oxide, magnesium hydroxide or mixtures of magnesium oxide and magnesium hydroxide. The magnesium compound advantageously comprises basic magnesium carbonate of general formula 4MgCO₃.Mg(OH)₂.4H₂O.

In addition to the sodium bicarbonate and the inhibitor, the reactive composition according to the invention can optionally comprise other constituents, for example sodium monocarbonate or active charcoal.

The reactive composition according to the invention preferably comprises more than 85% (advantageously at least 90%) by weight of sodium bicarbonate. Its content by weight of inhibitor is preferably greater than 0.5% (advantageously at least equal to 2%) of the weight of sodium bicarbonate. The content by weight of inhibitor generally does not exceed 10% (preferably 7%) of the weight of the sodium bicarbonate. In the case where the inhibitor comprises lignite coke, the latter is preferably present in an amount by weight of greater than 3% (advantageously at least equal to 5%) of the weight of the sodium bicarbonate. In the case where the inhibitor comprises a magnesium compound as defined above, the latter is preferably present in an amount by weight of greater than 1% (advantageously at least equal to 2%) of the weight of the sodium bicarbonate.

In the case where the reactive composition according to the invention comprises sodium monocarbonate (of general formula Na₂CO₃), it is desirable for its content by weight of sodium monocarbonate to be less than 2% (preferably at most equal to 1%) of the overall weight of sodium bicarbonate and sodium monocarbonate.

In an especially recommended embodiment of the composition according to the invention, the latter exhibits a particle size defined by a mean particle diameter of less than 50 μm (preferably at most equal to 30 μm) and a particle size slope of less than 5 (preferably at most equal to 3). In this embodiment of the invention, the mean diameter (Dₘ) and the particle size slope (σ) are defined by the following relationships:

$${D}_{\underline{m}} = \frac{\sum {n}_{\underline{1}} \times {D}_{\underline{1}}}{\sum {n}_{\underline{1}}} [ sic ] , σ = \frac{{D}_{\underline{90}} - {D}_{\underline{10}}}{{D}_{\underline{50}}} [ sic ]$$

in which nᵢ denotes the frequency (by weight) of the particles of diameter Dᵢ, and D_{π}(D₅₀ and D₁₀ respectively) represents the diameter at which 90% (50% and 10% respectively) of the particles of the reactive composition (expressed by weight) have a diameter of less than D₉₀ (D₅₀ and D₁₀ respectively). These particle size parameters are defined by the method of analysis by laser radiation scattering using a Sympatec measuring device, Helos 12LA model, manufactured by Sympatec GmbH.

According to another recommended embodiment of the composition according to the invention, the latter is substantially devoid of silica. The phrase “substantially devoid of silica” is understood to mean that the amount of silica in the reactive composition is insufficient to have a perceptible influence on the caking of the sodium bicarbonate, in the presence of atmospheric air, at a temperature of 20° C. and at standard atmospheric pressure. The composition according to the invention is preferably entirely devoid of silica. Everything else being equal, the composition in accordance with this embodiment of the invention exhibits optimum effectiveness as purification agent for gases.

The reactive composition according to the invention is applied as agent for the purification of gases contaminated by hydrogen chloride, hydrogen fluoride, sulphur oxides (mainly sulphur dioxide), nitrogen oxides (mainly nitric oxide NO and nitrogen peroxide NO₂), dioxins and furans. It is especially advantageously applied in the purification of the flue gases generated by incinerators of municipal waste or hospital waste.

The invention also relates to a process for the purification of a gas, according to which a reactive composition comprising sodium bicarbonate is introduced into the gas and the gas is subsequently subjected to removal of dust, the process being characterized in that the reactive composition is substantially devoid of silica.

In the process according to the invention, the reactive composition is introduced in the solid state into the gas. The temperature of the gas is generally greater than 100° C. (preferably greater than 125° C.) during the introduction of the reactive composition. It is recommended that the temperature of the gas should not exceed 800°°C., preferably 600° C. Temperatures of 140 to 250° C. are highly suitable. The reactive composition is generally introduced into a stream of gas moving in a reaction chamber. The contaminants of the gas are, in the reaction chamber, adsorbed on the sodium bicarbonate particles (in the case of dioxins or furans) or react with the latter to form solid waste (for example, sodium chloride or fluoride, sodium sulphate or sodium nitrite and nitrate, depending on whether the contaminants of the gas comprise hydrogen chloride, hydrogen fluoride, sulphur oxides or nitrogen oxides). The function of the removal of dust from the gas is to extract the solid waste thus formed therefrom. Dust removal can be carried out by any appropriate known means, for example by mechanical separation in a cyclone, by filtration through a filter cloth or by electrostatic separation. Filtration through a filter cloth is preferred.

In accordance with the invention, it has been found that reactive compositions comprising sodium bicarbonate which are substantially devoid of silica are more effective in the purification of gases than sodium bicarbonate compositions comprising silica. This improved effectiveness of the compositions according to the invention with respect to those comprising silica becomes evident mainly in the case where the removal of dust is carried out by means of a filter cloth. Although not wishing to be bound by a theoretical explanation, the inventors believe that this greater effectiveness of the silica-free compositions can be attributed to the fact that these compositions adhere better to the filter cloth than the silica-comprising compositions.

In an advantageous embodiment of the process according to the invention, the reactive composition which is introduced into the gas is in accordance with the reactive composition according to the invention defined above and comprises, for this purpose, lignite coke and/or a magnesium compound comprising magnesium (hydr) oxide.

The process according to the invention is especially advantageously applied in the purification of a flue gas originating from the incineration of municipal waste or hospital waste, this waste generally comprising chlorinated compounds and metal chlorides capable of generating hydrogen chloride during incineration. This waste generally also comprises heavy metals and sulphur-comprising waste, in particular sulphur dioxide, which are found at least partly in the flue gas. In this specific application of the process according to the invention, the solid product which is collected from the removal of dust consequently usually comprises, in addition to sodium chloride, heavy metals in the metallic or combined state, as well as sodium carbonate and sodium sulphate. This solid product can be treated in the way set out in International Application WO 93/04983 [Solvay (Société Anonyme)].

The process according to the invention is also applied in the purification of flue gases generated by the combustion of fossil fuels (natural gas, liquid petroleum derivatives, coal), these flue gases being contaminated by sulphur dioxide and nitrogen oxides.

Furthermore, the process according to the invention is applied in the purification of fuel gases obtained by coal gasification, these gases generally being contaminated by hydrogen chloride, hydrogen fluoride and sulphur dioxide.

The advantage of the invention will emerge from the description of the following examples, with reference to the appended drawings.

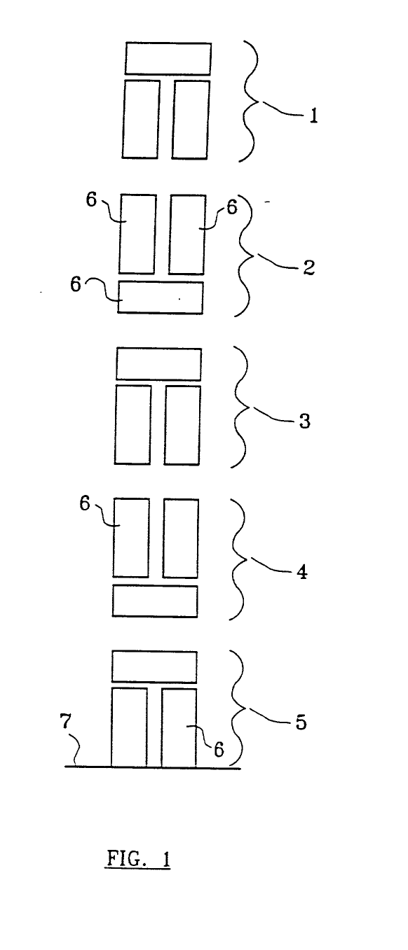

FIG. 1 diagrammatically shows a stack of bags comprising a reactive composition;

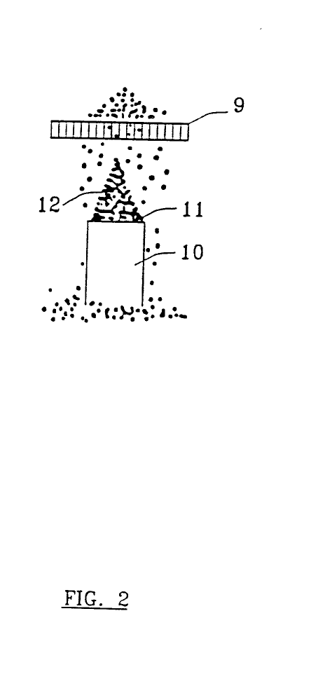

FIG. 2 diagrammatically shows a device used to define the mobility of a pulverulent reactive composition.

In these figures, the same reference numbers denote identical components.

First Series of Tests

Examples 1 to 6 relate to storage tests on reactive compositions in accordance with the invention, with the aim of assessing their resistance to caking. To this end, in each of these examples, a solid and pulverulent reactive composition was bagged up in 15 polyethylene bags weighing 40 kg, which bags were hermetically sealed. The 15 bags were stacked on a support 7, in the way represented in FIG. 1, so as to form five rows (1, 2, 3, 4, 5) of three bags 6, and the stack of bags was stored in a warehouse with normal ventilation which is maintained at ambient temperature. After storage, the bags were opened, samples were withdrawn therefrom in a random manner and two tests were carried out on the samples withdrawn. A first test served to define the tendency of the composition to cake. The second test served to evaluate the mobility of the reactive composition, that is to say its ability to flow freely.

For the test targeted at defining the tendency to cake, the bags were poured out onto a graded screen with rectangular mesh openings of 12×19 mm and the degree of caking of the powder was defined by the relationship

D=(Amount by weight of agglomerates retained on the screen/Total weight of powder poured onto the screen)×100

For the test targeted at defining the mobility of the reactive composition, use was made of the device represented diagrammatically in FIG. 2. The device comprises a sieve 9, exhibiting a mesh size of 710 μm, positioned above a vertical cylinder 10 with a diameter of 50 μm. For the test, the powder was poured through the sieve, the powder was collected on the top horizontal face 11 of the cylinder 10 and the maximum height of the cone of powder 12 formed on the face 11 of the cylinder 10 was measured. According to this test, the mobility of the powder increases as the height of the cone 12 decreases.

### EXAMPLE 1

In this example, use was made of a reactive composition comprising milled and screened sodium bicarbonate, 0.48% by weight of silica and 4.6% by weight of lignite coke (the contents of silica and of lignite coke are expressed with respect to the weight of sodium bicarbonate). The screening of the sodium bicarbonate was adjusted so that the latter is in the form of particles not exceeding 13 μm in diameter, the reactive composition exhibiting a particle size defined by the following characteristics (defined above), expressed in μm:

D10 [sic]=7.0

D50 [sic]=29.7

D90 [sic]=70.3

After storage for three months, the composition was subjected to the two tests defined above. The following results were obtained:

Tendency to cake (test on three samples):

Sample No. 1: 0.50%

Sample No. 2: 2.98%

Sample No. 3: 0.11%

Mobility (test on five samples):

Sample No. 1: 40 mm

Sample No. 2: 36 mm

Sample No. 3: 40 mm

Sample No. 4: 39 mm

Sample No. 5: 38 mm

Mean :39 mm

### EXAMPLE 2

The tests of Example 1 were repeated with a reactive composition comprising milled and screened sodium bicarbonate, 1.89% by weight of basic magnesium carbonate and 5% by weight of lignite coke (the contents of basic magnesium carbonate and of lignite coke are expressed with respect to the weight of sodium bicarbonate [lacuna]. The screening of the sodium bicarbonate was adjusted as in Example 1, so that it is in the form of particles not exceeding 13 μm in diameter, the reactive composition exhibiting a particle size defined by the following characteristics (defined above), expressed in μm:

D10 [sic]=6.6

D50 [sic]=33.7

D90 [sic]=75.4

After storage for three months, the following results were obtained:

Tendency to cake (test on three samples): 0%

Mobility (test on five samples):

Sample No. 1: 34 mm

Sample No. 2: 38 mm

Sample No. 3: 37 mm

Sample No. 4: 36 mm

Sample No. 5: 39 mm

Mean :37 mm

### EXAMPLE 3

The tests of Example 1 were repeated with a reactive composition comprising milled and screened sodium bicarbonate and 5.1% by weight of lignite coke, the content of lignite coke being expressed with respect to the weight of sodium bicarbonate. The screening of the sodium bicarbonate was adjusted as in Example 1, so that it is in the form of particles not exceeding 13 μm in diameter, the reactive composition exhibiting a particle size defined by the following characteristics (defined above), expressed in μm:

D10 [sic]=7.0

D50 [sic]=35.1

D90 [sic]=85.0

After storage for three months, the following results were obtained:

Tendency to cake (test on three samples): 0%

Mobility (test on five samples):

Sample No. 1: 37 mm

Sample No. 2: 38 mm

Sample No. 3: 41 mm

Sample No. 4: 40 mm

Sample No. 5: 38 mm

Mean :39 mm

The preceding examples show that the reactive compositions in accordance with the invention correctly endure storage for several months. A comparison of the results of Examples 2 and 3 with those of Example 1 furthermore show [sic] that the absence of silica in the reactive composition is not harmful to its ability to be stored.

### EXAMPLES 4 to 6

In Examples 4 to 6, the tests of Example 1 to 3 respectively were repeated with a storage time of six 10 months. The characteristics of the compositions are given in Table 1 below.

TABLE 1

| | Examples [sic] No. | | |
|---|---|---|---|
| | 4 | 5 | 6 |
| Silica (%) | 0.5 | | |
| Basic magnesium carbonate (%) | | 2 | |
| Lignite coke (%) | 5 | 5 | 5 |
| D10 [sic] (μm) | 7.6 | 12.3 | 7.7 |
| D50 [sic] (μm) | 30.0 | 41.2 | 36.7 |
| D90 [sic] (μm) | 69.1 | 83.4 | 79.4 |

The results obtained after storage for six months are given in Table 2 below.

TABLE 2

| | Examples [sic] No. | | |
|---|---|---|---|
| | 4 | 5 | 6 |
| Tendency to cake | | | |
| Sample No. 1 | 0 | 0 | 0 |
| Sample No. 2 | 3.2 | 0 | 0 |
| Sample No. 3 | 3.1 | 0 | 0 |
| Sample No. 4 | 1.8 | 0 | 0 |
| Sample No. 5 | 0 | 0 | 0 |
| Mobility | | | |
| Sample No. 1 | 43 | 29 | 43 |
| Sample No. 2 | 41 | 30 | 38 |
| Sample No. 3 | 46 | 29 | 43.5 |
| Sample No. 4 | 44 | 28 | 45 |
| Sample No. 5 | 43 | 30 | 41 |

Examples 4 to 6 confirm the results of Examples 1 to 3 by demonstrating the excellent ability of the silica-free reactive compositions according to the invention.

Second Series of Tests

Examples 7 to 10 relate to tests carried out with the aim of measuring the effectiveness of reactive compositions in purifying a gas from hydrogen chloride.

The gas treated in each test was a flue gas originating from an incinerator of domestic waste comprising hydrogen chloride and sulphur dioxide. An at least sufficient amount of a reactive composition comprising sodium bicarbonate was introduced into the flue gas to bring its residual content of hydrogen chloride below 50 mg/Sm³ (European Standard 89/369/EEC) or below 10 mg/Sm³ (European Standard 94/67/EEC or German Standard 17.BIm SchV). After addition of the reactive composition, the flue gas was filtered through a filter cloth to remove dust therefrom.

### EXAMPLE 7 (In accordance With the Invention)

In this example, the reactive composition employed consisted essentially of sodium bicarbonate, without additive. In particular, the reactive composition was devoid of silica.

The test lasted 390 minutes. During the test, the flow rate of the flue gas, the throughput of the reactive composition introduced into the flue gas and the contents of hydrogen chloride and of sulphur dioxide in the flue gas were continuously measured, respectively upstream of the addition of the reactive composition and downstream of the filter cloth. From these measurements, the stoichiometric ratio (S.R.) of the amount of sodium bicarbonate actually employed to the stoichiometric amount required, on the one hand, and the degree of purification from hydrogen chloride, the latter being defined by the relationship

τ=((HClᵢ−HCl_{f})/HClᵢ)×100

where HClᵢ denotes the content of hydrogen chloride in the flue gas upstream of the addition of the reactive composition and HCl_{f} denotes the content of hydrogen chloride in the flue gas downstream of the said addition [sic], on the other hand, were calculated. In the test, the stoichiometric amount of sodium bicarbonate is that required to remove the hydrogen chloride and the sulphur dioxide from the flue gas, according to the following theoretical reactions:

HCl+NaHCO₃→NaCl+H₂O+CO₂

SO₂+2NaHCO₃+1/2O₂→Na₂SO₄+H₂O+2CO₂

The results of the test (arithmetic mean over the 390 minutes) are recorded below:

| Flue gas | |
|---|---|
| Flow rate (Sm³/h) | 2378 |
| HClᵢ (mg/Sm³) | 1530 |
| HCl_{f} (mg/Sm³) | 9 |
| Reactive composition: | |
| NaHCO₃ throughput (kg/h) | 13 |
| S.R. | 1.49 |
| Degree of purification (%) | 99.4 |

### EXAMPLE 8 (Not in Accordance with the Invention)

The test of Example 7 was repeated with a reactive composition composed of sodium bicarbonate and silica (0.5 g of silica per 100 g of sodium bicarbonate). The results of the test (which lasted 360 minutes) are given below.

| Flue gas | |
|---|---|
| Flow rate (Sm³/h) | 1697 |
| HClᵢ (mg/Sm³) | 2018 |
| HCl_{f} (mg/Sm³) | 39 |
| Reactive composition: | |
| NaHCO₃ throughput (kg/h) | 26 |
| S.R. | 3.07 |
| Degree of purification (%) | 98.1 |

A comparison of the results of Example 7 (in accordance with the invention) with those of Example 8 (not in accordance with the invention) immediately reveals the advantage of avoiding, in accordance with the invention, the presence of silica in the reactive composition.

### EXAMPLE 9 (In Accordance With the Invention)

The test of Example 7 was repeated with a reactive composition in accordance with the invention which is devoid of silica and is composed of a homogeneous mixture of sodium bicarbonate and basic magnesium carbonate (2 g per 100 g of sodium bicarbonate). The results of the test (which lasted 67 hours) are given below.

| Flue gas | |
|---|---|
| Flow rate (Sm³/h) | 24,000 |
| HClᵢ (mg/Sm³) | 1060 |
| HCl_{f} (mg/Sm³) | 32 |
| Reactive composition: | |
| NaHCO₃ throughput (kg/h) | 63.7 |
| S.R. | 1.11 |
| Degree of purification (%) | 99.0 |

### EXAMPLE 10

The test of Example 7 was repeated with a reactive composition in accordance with the invention which is devoid of silica and is composed of a homogeneous mixture of sodium bicarbonate and lignite coke (5 g per 100 g of sodium bicarbonate). The results of the test (which lasted 81 hours) are given below.

| Flue gas | |
|---|---|
| Flow rate (Sm³/h) | 24,000 |
| HClᵢ (mg/Sm³) | 925 |
| HCl_{f} (mg/Sm³) | 46 |
| Reactive composition: | |
| NaHCO₃ throughput (kg/h) | 63.8 |
| S.R. | 1.09 |
| Degree of purification (%) | >99.9 |

Example 9 and 10 show the positive influence of the basic magnesium carbonate and lignite coke on the effectiveness of the reactive composition.

1. Solid pulverulent reactive composition for the purification of a gas, comprising sodium bicarbonate and a caking inhibitor for sodium bicarbonate, characterized in that the inhibitor comprises lignite coke and/or a magnesium compound comprising magnesium (hydr)oxide.

2. Composition according to claim 1, characterized in that it is substantially devoid of silica.

3. Composition according to claim 1 or 2, characterized in that the magnesium compound comprises basic magnesium carbonate.

4. Composition according to any one of claims 1 to 3, characterized in that it comprises at least 90% by weight of sodium bicarbonate and in that its content by weight of inhibitor is greater than 0.5% of the weight of sodium bicarbonate.

5. Composition according to claim 4, characterized in that, in the case where the inhibitor comprises a magnesium compound, the latter is present in an amount by weight at least equal to 2% of the weight of sodium bicarbonate.

6. Composition according to claim 4, characterized in that, in the case where the inhibitor comprises lignite coke, the latter is present in an amount at least equal to 5% of the weight of sodium bicarbonate.

7. Process for the purification of a gas, according to which a reactive composition comprising sodium bicarbonate is introduced into the gas and the gas is subjected to removal of dust, characterized in that the reactive composition is substantially devoid of silica.

8. Process according to claim 7, characterized in that the removal of dust comprises filtration through a filter cloth.

9. Process according to claim 7 or 8, characterized in that the reactive composition is in accordance with any one of claims 2 to 6.

10. Process according to any one of claims 7 to 9, for the purification of a gas from at least one contaminant selected from hydrogen chloride, hydrogen fluoride, sulphur oxides, nitrogen oxides, dioxins and furans.
